(19) United States
(12) Patent Application Publication
(10) Pub. No.: US 2008/0126947 A1
(43) Pub. Date: May 29, 2008

(54) Customizable User Interface

(76) Inventors: Brian R. Cartmell, Mercer Island, WA (US); Ryan Porter, Spokane, WA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/538,481

(22) Filed: Oct. 4, 2006

(51) Int. Cl. G06F 3/00

(52) U.S. Cl. 715/747

(57) ABSTRACT

Published themes are combined with user provided content to create instantiations of software applications which include a graphical user interface. Modification of a published theme results in modification of previous instantiations.

### TECHNICAL FIELD

The technical field of the invention relates generally to the area of graphical user interfaces for computer software and hardware systems.

### BACKGROUND

Graphical user interfaces have become an indispensable part of computer software and hardware systems. In a broad sense, even a text-based command-line user interface could be thought of as “graphical,” inasmuch as any digital computer system manipulates binary units; text, as a graphical representation of the binary units, is a graphical abstraction of the underlying binary units. However, in common parlance, a “command line interface” is one which is text-based, while a graphical user interface or “GUI” involves the presentation and manipulation of graphical elements such as hypertext links, windows, buttons, scroll bars, pointers, and menus, also known as “chrome.” Individual of such chrome elements are called “widgets.”

Interaction with widgets in a GUI is typically accomplished through the use of an input device such as a mouse or a stylus, though may also be accomplished through keyboard input or voice and/or speech recognition input.

If the chrome of an application can be modified by users—with it sometimes being the case that modifications can be saved as a file under a name or other identifier—then a particular instance of a user-modified chrome is called a “skin” or a “theme” (hereinafter referred to as a “theme”). The prior art has provided means to allow users to modify application chrome and to publish such chrome as a themes which other users can apply to their own version of the application software. See, for example, http///msdn.microsoft.com/library/default.asp?url=/library/en-us/wmplay10/mmp_sdk/aboutskins.asp, reproduced in substantial part in FIG. 5. When another user wishes to apply a published (or otherwise existing) theme to such other user's instance of the software application, also referred to hereinafter as an “instantiation” of the theme, the user typically downloads the published theme as a file which represents a set of preference selections with respect to the modifiable chrome. The file may be saved in a particular location or with a particular extension (or otherwise with a particular name) which allows the software application to find the theme file and to apply the preference selections with respect to the modifiable chrome. A party looking for a theme may be provided with the opportunity to select from more than one and, in certain cases, hundreds of published themes.

Modification, publication, and instantiation of themes has become important in the context of social networking portals such as MySpace, Facebook, and Carster, where service providers compete at least in part on ability to provide themes which are both easily instantiated and readily customizable.

While the art has provided for user-modified themes, and while the art has provided for user-modified themes which can be published, the art has not provided a way to allow the publisher of a theme which has already been instantiated to modify the published theme and to then have the modifications applied to previous instantiations of the theme, unless the party who previously instantiated the theme takes some affirmative action (such as, for example, by actively electing to re-download the modified theme and re-apply the theme to the software application).

### BRIEF SUMMARY OF THE INVENTION

The present invention allows selection of existing themes, modification of themes, publication of user-modified themes, instantiation of user-modified themes, modification of a previously published theme, and the application—without user interaction—of such modifications to instances of the theme which have already been instantiated.

### BRIEF DESCRIPTION OF THE DRAWINGS

FIG. 1 is a process flow chart of exemplary steps consistent with the principals of the invention.

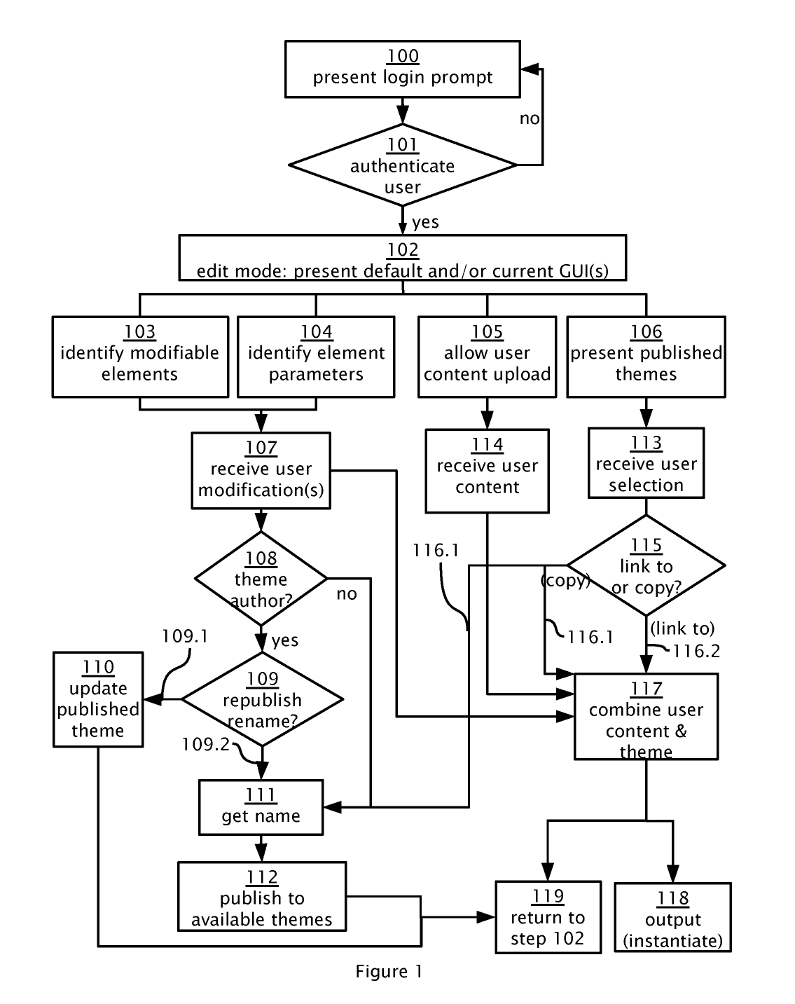

FIG. 2 is an exemplary diagram of a computer system in and through which systems and methods consistent with the principals of the invention may be implemented.

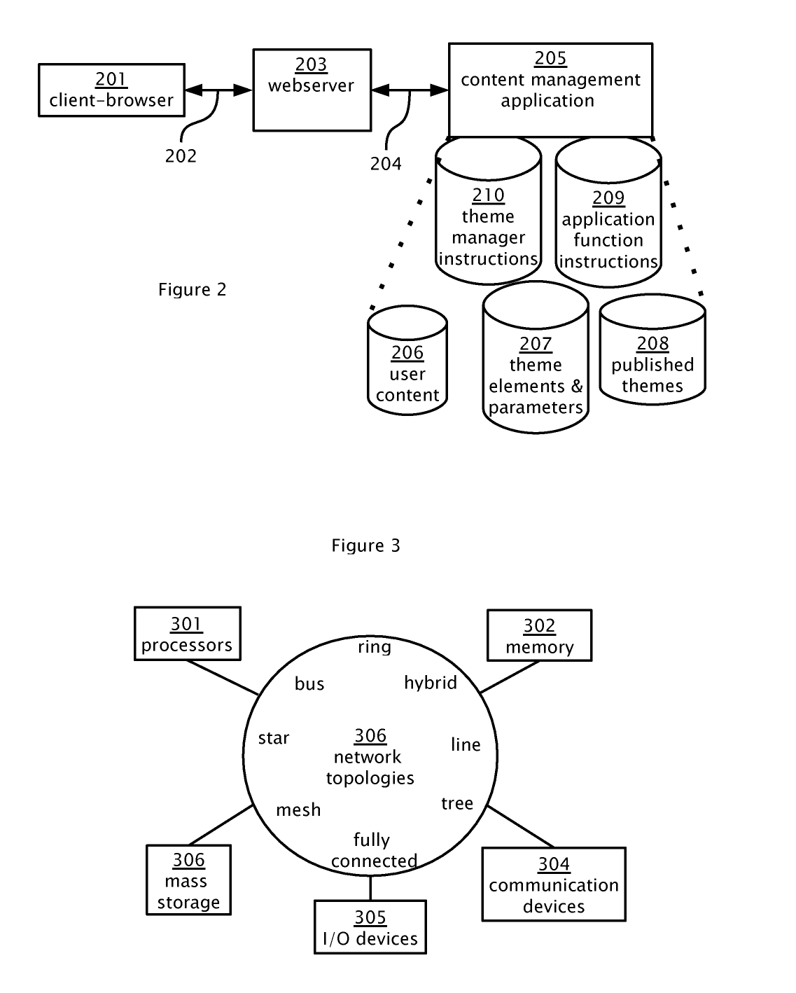

FIG. 3 is an exemplary diagram of a computer system in and through which systems and methods consistent with the principals of the invention may be implemented.

FIG. 4 is a process flow chart of exemplary steps consistent with the principals of the invention.

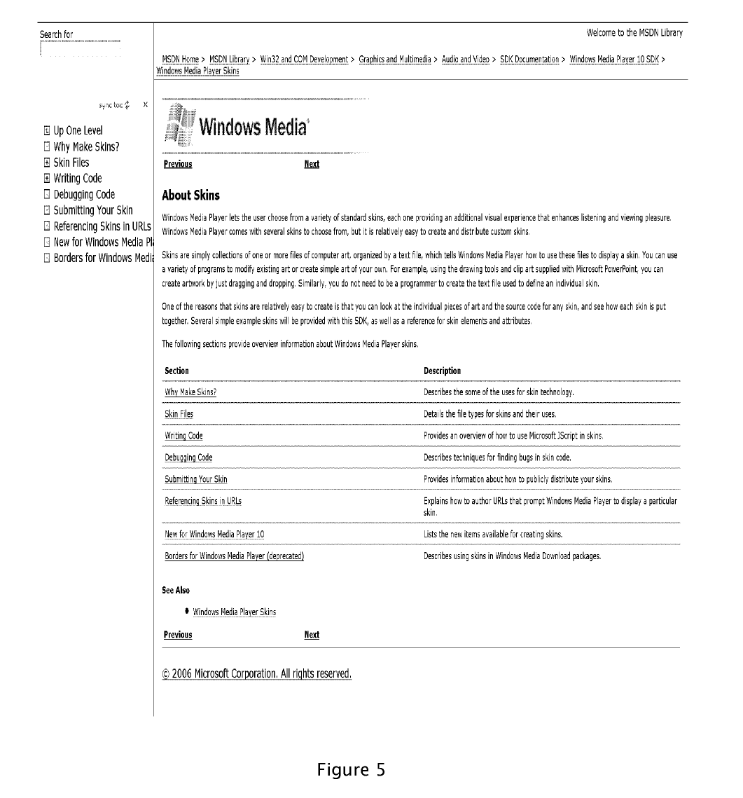

### DETAILED DESCRIPTION

The following detailed description refers to the accompanying drawings. The same reference numbers in different drawings identify the same or similar elements. The following detailed description is for the purpose of illustrating embodiments of the invention only, and other embodiments are possible without deviating from the spirit and scope of the invention, which is limited only by the appended claims.

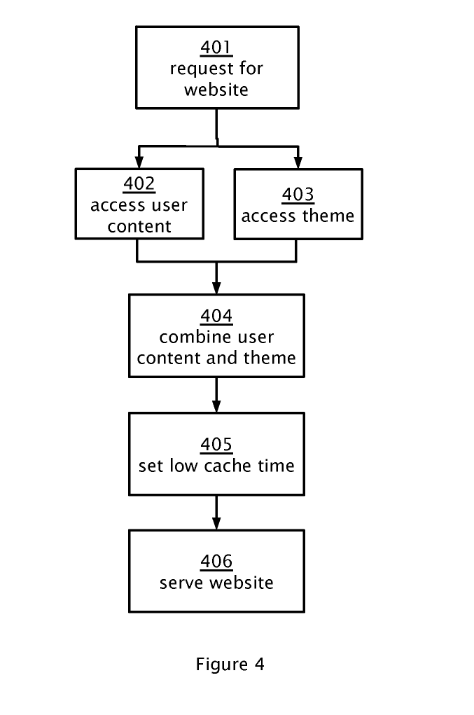

Referring to the figures, the user of a computer system, exemplified by FIG. 3, running software which includes a GUI 201 attempts to access the system using a communication channel 202. The depiction in Figure Two presents the computer system running software which includes a GUI 201 as a client-browser (a computer system running browser software) utilizing a communication channel 202 to communicate with a webserver 203. Practitioners skilled in the art will appreciate that the computer system including a GUI need not be a browser, but may be a computer system running any software which includes a GUI and that the software which includes a GUI may include a word processing program, a spreadsheet, a customer relations management application, an audio/video player, or any other computer system running any software which includes a GUI. In such case, the webserver 203 need not be a webserver, but may include any server, including a server application which may operate on the same computer system as the computer system running software which includes a GUI 201 or on a different computer system. A typical webserver or server system 203 is also exemplified by FIG. 3.

A review of Figure Three of the drawings will indicate to a practitioner skilled in the art that the exemplary computer system—one which may be used to form the computer system which includes a GUI 201, the server 203, the content management application 205—may be distributed and virtualized to differing degrees, with centralized management or without, in the case of a peer-to-peer version of the disclosed invention. As is known in the art, the architectures for distributed computer programs follow along the following lines: client-server, 3-tier architecture, N-tier architecture, and utilizing distributed objects to varying degrees, with none, loose or tight coupling, and with stateless or stateful transactions. Any architecture or a mix of architectures may be utilized to implement the disclosed invention or a component thereof.

The communication channel 202 would be tailored to the computing environment, and may include any physical layer and physical layer protocols (wire, fiber optic cable, wireless transceivers, etc., in conjunction with RS-232, RS-422, RS-423, DSL, ISDN, 100BASE-T, SONET/SDH, etc.), any compatible data link layer protocol (Ethernet, IEEE 802.x, Token ring, PPP, FDDI, ATM, DTM, Frame Relay, etc.) any compatible network layer (IP, ICMP, IGMP, ARP, RARP, etc.), any compatible transport layer (TCP, UDP, DCCP, SCTP, IL, RUDP, etc.), any compatible session layer (ADSP, ASP, H.245, iSNS, L2F, NetBIOS, PPTP, RPC, RTP, etc.), any compatible presentation layer (AFP, LPP, NCP, NDR, XDR, X.25 PAD, etc.), and potentially including any compatible application layer (APPC, BitTorrent, BOOTP, CFDP, DCAP, DHCP, DNS, ENRP, FTAM, FTP, HTTP, etc.). Practitioners skilled in the art will appreciate the various ways in which a communication channel 202 may be achieved between a computer running software which includes a GUI 201 and a server 203.

The computer system running software which includes a GUI 201 optionally presents a login prompt 100 to confirm that the user is authorized to access the system. Alternatives to presenting a login prompt (not shown) include determining whether the user is an authorized user of the computer system which hosts the software which includes a GUI, for example and without limitation, by determining if the user's “keychain” or “wallet” authenticates the user or by allowing the user to access the system if the user is logged into the computer system which hosts the software which includes a GUI (a “keychain” or “wallet” is understood to be a password and login management system, such as Apple's “Keychain” or Microsoft's “Wallet”). The user submits login information (not shown) and the system attempts to authenticate the user 101. If authentication is not successful, the system optionally returns to the login prompt 100 or a variation thereof (indicating, for example, that the login attempt failed and presenting one or more additional opportunities to login). The system may also be inaccessible until such time as the user successfully logs into the host computer system.

If authentication is successful, the system optionally proceeds to a mode which allows a GUI to be edited 102. The GUI to be edited may be a default GUI if the user has not accessed the system previously or the GUI may be the product of the user's previous interactions with the system, in which case there may also be an election (not shown) to select among draft GUI edits.

In the GUI editing mode, the system may output a graphical rendition of the GUI to be edited (also represented at 102) and/or may, in a non-exclusive embodiment, output information regarding the current GUI (not shown) such that the current GUI is described to the user using text and/or computer code. For example, and without limitation, the system may output cascading style sheets, “CSS,” which the user may modify and/or the system may output a graphical rendition of the GUI to be edited along with one or more frames which display the CSS entries for selected chrome elements. The purpose of such output is to identify modifiable chrome elements 103 and the element parameters 104, which is discussed further below.

The system optionally allows the user to upload content 105 into the system, such as, for example and without limitation, pictures, sounds, text, or programming code and/or instructions. In a distributed and/or peer-to-peer system, the system might identify the location of the content, rather than and/or in addition to uploading the user content. The system provides (not shown in the figures) that various of the uploaded content may be associated with one or more specific elements of the chrome. If the user uploads content, the system receives the uploaded content and may optionally proceed to combine the uploaded content with the current theme 117, to re-output the current GUI in the GUI edit mode 102, and to instantiate the GUI generally as shown in Figure Four (more on this last step below).

The system optionally allows the user to select from existing published themes 106 which may include a blank or default theme (not shown). The system receives the user's selection, if any, with regard to a published theme 113, and provides that the user may link to or may copy a published theme 115. It would be understood by a practitioner skilled in the art that providing that the user may link to or copy a published theme may be accomplished during a different step, such as in the presentation of published themes 106 and in the receipt of the user selection 113, without materially altering the invention.

If the user links to 116.2 a published theme, the system may optionally proceed to combine 117 the product of receiving content from the user 114, if any, with the selected theme 113, and to return to the GUI editing mode 102, and to instantiate the software application including a GUI 118, Figure Four. A theme which is linked to 116.2 is not modified by the user, other than through combination of the user's content with the theme 117. Throughout this application, a combination of a user's content with a theme 117 is not a modification of a theme, but use of or, equivalently, an instantiation of a theme.

If the user copies a published theme, then, in no particular order, the system may optionally proceed to combine the received user content 114, if any, with the then-current theme (the copied theme) 117, to return to the GUI editing mode 102, and to instantiate the software application including a GUI 118 and Figure Four. In addition, the system may optionally request and/or obtain from the user a name to associate with the copied theme 111, in which event the system may optionally publish the theme under the new name (with or without replacing the previously published theme which had been copied) and may return to step 102 of the GUI edit mode, such that the user may make changes to the copied theme and/or may take other action(s) allowed at step 102.

It would be understood by a practitioner in the art that equivalent terms may be substituted for “link to” or “copy,” without changing the scope or implementation of the invention.

In the GUI edit mode, 102, the system may also identify modifiable elements of the then-current theme 103 as well as parameters for the modifiable elements 104. Identification of modifiable elements of the then-current theme 103 and of element parameters 104 may be accomplished in various ways. For example and without limitation, the modifiable elements may be highlighted and/or colored in a distinctive manner in the GUI edit mode 102, while a right-click or similar interaction with the modifiable elements 103 may result in identification of the parameters 104, which parameter presentation 104 may be selectable or which may otherwise provide for similar user input regarding the elements 103 and the element parameters 104. In a non-exclusive alternative embodiment, the modifiable elements 103 and the element parameters 104 may be presented in a list, accompanied by exemplary graphics, which list may be presented in the same or a different screen from that used to display the GUI edit mode 102. In a non-exclusive alternative embodiment, the modifiable elements 103 and the element parameters 104 may be modifiable through use of command-line or similar user input 107 without explicit identification of the modifiable elements 103 and/or of the element parameters 104. Or, as noted above the system may CSS and/or a graphical rendition of the GUI to be edited along with frames or equivalent containing corresponding CSS entries. The purpose of such output is to identify modifiable chrome elements 103 and the element parameters 104.

The user sets parameters 104 with respect to the modifiable elements 103, communicates 202 the parameters to the system, and the system receives the user's modification(s) 107. Selection, transmission of, and receipt of the user's modifications may be accomplished in any number of a variety of ways which are well known in the art, including through the use of client- or server-side scripts, hyperlinks representing the various selection alternatives, applets, uploading edited CSS, or similar.

Prior to or after receipt of the user's modifications 107, the system may determine if the user is the author of the theme which the user may be modifying 108. Drawing figure one depicts step 108 as following step 107, but it will be appreciated by those skilled in the art that step 108 may come before step 107 (at any time in the GUI edit mode) without changing the basic nature of the invention. When the system determines 108 that the user is the theme author, the system may provide the user with the option to republish and/or rename the theme. If the user elects to republish the theme 109.1, the system updates the published theme 110 with the received user modification(s) 107. If the user elects to rename the theme and/or if the user was found not to be the theme author 108, the system may optionally request and/or obtain from the user a name to associate with the modified theme 111, in which event the system may optionally publish the theme under the new name 112 (with or without replacing the previously published theme which had been copied) and may return to step 102 of the GUI edit mode, such that the user may make changes to the theme and/or may take other action(s) allowed at step 102.

After a theme has been selected, modified, created, and/or associated with uploaded content by a user in the GUI edit process depicted generally in figure one, the system provides that the computer system operating the software which includes a GUI 201 may be made available other than in the GUI edit process 118; i.e. the software application including a GUI is instantiated and made available for its intended use by a party who requests it (which party may be the user who modified the GUI and/or by third parties). This shall be referred to herein as an “instantiation” of the theme. An exemplary depiction of such a process is depicted in figure four, while figure two serves as a depiction of a system for implementing the process depicted in figure one and/or figure four. The depiction in figure four and the following describes that the computer system operating the software which includes a GUI 201 is running browser software; however the computer system operating the software which includes a GUI 201 need not be limited to running browser software, but may be running a word processing program, a spreadsheet, a customer relations management application, an audio/video player, or any other computer system running any software which includes a GUI.

The system may instantiate the software application(s) which include a GUI in the following way: The system may receive at a webserver and/or server 203 a request from a browser or another software application running in a computer system 201 for a website or webpage or for another software application which includes a GUI that is linked (by the process depicted in figure one) to a published theme 208. The system may utilize a content management application 205, which content management application 205 may access the user uploaded content 402 and the published theme(s) 403 associated therewith. The content management application 205 combines 404 the user content 206 and the then-current version of the published theme 208, and returns via a communication path 204 the website or webpage and/or another software application which includes a GUI to the webserver or server 203 for transmission via a communication path 202 to the browser and/or another software application running in a computer system 201. In another implementation, the webserver or server 203 is configured to combine the user content 206 and the then-current version of the published theme 208, receiving these components from the content management application 205.

If the website or webpage and/or another software application(s) which includes a GUI is linked to an existing theme which is modified according to the process described above and depicted in figure one, the system may update the website or webpage and/or another software application(s) which includes a GUI with the modified theme in any of the following ways: With respect to a browser, the browser may be configured to refresh itself frequently, for example by setting the “expires” header(s) in HTML to reference a date in the past to prevent the browser from caching a previously received response which embodies some or all of the GUI and/or the cache-control response header(s) max-age=[seconds], s-maxage=[seconds], no-cache, no-store, must-revalidate, and/or proxy-revalidate may be set to force refreshing or revalidation. In a Javaservlet, caching may be disabled, as in these examples:

response.setHeader( “Pragma”, “no-cache” );
response.addHeader( “Cache-Control”, “must-revalidate” );
response.addHeader( “Cache-Control”, “no-cache” );
response.addHeader( “Cache-Control”, “no-store” );
response.setDateHeader(“Expires”, 0);

Similarly, technologies such as Java Applets, ActiveX, Flash, inline frames, LiveConnect, C, C++, Java, Javascript, and XML may be used to render the GUI, all of which may be used to avoid caching of or to force frequent requests by the browser-client 201 for the latest version of the GUI, all of which might be characterized as a “pull” approach to ensure that the latest version of the linked theme is being utilized.

In an alternative “push” approach, the browser-client 201 (which, again, need not be a browser), may register itself through various means which are well known in the art with the server or webserver 203. In this alternative, when the server or webserver 203 receives information that a published theme has been modified, the server or webserver 203 uses the registration information to send (“push”) the modified GUI to the client-browser 201.

In an alternative distributed approach, the browser-client 201 and/or the server or webserver 203 is part of or has access to a network of peers or equivalent which circulate the current published themes according to a distributed hash table or equivalent. This might be considered a hybrid “push-pull” system.

It will be apparent to a practitioner skilled in the art that there exist and will exist a range of ways to distribute the processing, memory, storage, and communication loci between the client-browser 201 and the server or webserver 203 with respect to rendering the application which includes the GUI. At one end of the range, the client-browser 201 may perform a fairly passive role in which it primarily renders graphics-all of which are supplied by the server or webserver 203—and passively relays user input to the server or webserver 203. At this end of the range, the server or webserver 203 (which may itself be distributed) performs almost all of the processing, memory, storage, and communications operations required to make possible the functionality of the application which includes a GUI while the client-browser acts fulfills the role of a display terminal. At the other end of the range, the client-browser 201 performs most of these functions, while the server or webserver 203 fulfills a more passive role of maintaining a central repository (or, in the case of a distributed approach, maintaining a distributed repository) of the instructions for the generalized case of the application which includes a GUI. Practitioners skilled in the art will appreciate that there exist and will exist a range of ways to distribute the workload and resources between the client-browser 201 and the server or webserver 203 consistent with the spirit and scope of the invention.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

What is claimed is:

1. A method for modifying a GUI for a software application, comprising the following steps, not necessarily in the following order:
providing at least one theme including chrome elements;
associating at least one chrome element with at least one chrome element parameter, the chrome element parameter being modifiable;
allowing the chrome element parameter to be user-modifiable;
identifiably publishing a set of chrome elements and chrome element parameters as a theme, the published theme being able to be instantiated as the software application including the GUI; and
causing changes to be made to previous instantiations if the published theme upon which such previous instantiations are based changes.

2. The method according to claim 1, further comprising:
providing for submission and receipt and/or identification of the location of user provided content.

3. The method according to claim 2, further comprising:
providing that at least one chrome element(s) incorporate and/or display and/or perform some and/or all of certain user provided content.

4. The method according to claim 1 further comprising:
determining if a user who attempts to modify a published theme is the author of the published theme;
where, if the user is not the author of the published theme, requiring that the modifications to the theme be published under a different identifier; and/or
where, if the user is the author of the selected published theme, allowing the user to make modifications to the published theme.

5. The method according to claim 4, where, if the user is the author of the published theme, allowing the user to make modifications to the published theme and providing the option for the user to re-publish the modified theme under a different identifier, preserving the original published theme under the original identifier without modification.

6. A method according to which a software application including a GUI may be instantiated, comprising the following steps, not necessarily in the following order:
identifying the location of and/or receipt of user provided content;
enabling selection of a published theme;
combining the user provided content and the selected published theme, the combination being an instantiation of a software application including a GUI;
making the instantiation available to at least one requestor;
if the selected published theme is modified, providing an option whereby previously provided instantiations are updated.

7. The method according to claim 6, wherein the option to update previous instantiations is controlled by the requestor.

8. The method according to claim 6, wherein the option to update previous instantiations is an option controlled by the author of the published theme.

9. A computer system to provide a GUI for a software application comprising:
a first data structure in which to store and/or identify user provided content;
a second data structure in which to store at least one theme chrome element and at least one chrome element parameter;
a third data structure in which to store at least one uniquely identifiable published theme;
computer implemented instructions that, when implemented, create software application functionality, instantiate a theme, and update an instantiation if there occurs a modification to the uniquely identifiable published theme upon which the instantiation is based;
computer implemented instructions that, when implemented, allow modification and publication of theme chrome elements and chrome element parameters;
at least one computer processor suitable to execute instructions;
at least one communication system which provides communication between at least one data structure and the at least one computer processor;
at least one communication system which provides communication between a user who modifies a theme and the at least one computer processor;
at least one communication system which provides communication between at least one requester of a theme instantiation and the at least one computer processor.

10. The computer system according to claim 9 wherein the first, second, and/or third data structures share a common data structure.

11. A computer-readable medium encoded with computer-executable components that implement a software application including a GUI, the computer-executable components comprising:
a first data structure in which to store user provided content and/or the location of user provided content;
a second data structure in which to store at least one theme chrome element and at least one chrome element parameter;
a third data structure in which to store at least one uniquely identifiable theme, the at least one uniquely identifiable theme including the at least one theme chrome element and the at least one chrome element parameter;
a theme manager configured to allow modifications to be made to at least one uniquely identifiable theme; and
an instantiation manager configured to update instantiations of the at least one uniquely identifiable published theme in accordance with modifications to the uniquely identifiable published theme upon which such instantiation is based.
